(19) United States
(12) Patent Application Publication
(10) Pub. No.: US 2024/0429632 A1
(43) Pub. Date: Dec. 26, 2024

(54) CHIP CONNECTOR WITH IMPROVED TERMINALS

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventors: FANG-JWU LIAO, New Taipei City (TW); JIA-HAU LIU, New Taipei (TW); CHIA-RU CHANG, New Taipei (TW)

(21) Appl. No.: 18/748,510

(22) Filed: Jun. 20, 2024

(30) Foreign Application Priority Data
Jun. 21, 2023 (CN) 202310745147.2

(51) Int. Cl. H01R 12/71; H01R 12/57; H01R 13/24; H01R 13/41

(52) U.S. Cl. CPC H01R 12/716; H01R 12/57; H01R 13/2442; H01R 13/2478; H01R 13/41

(57) ABSTRACT

A chip connector includes: an insulative housing defining an upper face, a lower face, and plural terminal grooves extending through the upper face and the lower face; and plural conductive terminals received in the terminal grooves respectively, each terminal including a fixing portion, an elastic arm extending from the fixing portion, a tail portion, and an accessory portion, the elastic arm including an upward portion, an inclined portion extending obliquely from the upward portion, and a contacting portion bending from the inclined portion, wherein the accessory portion comprises a slanting portion with a resisting portion at a free end thereof, the slanting portion faces and extends toward the fixing portion, and the inclined portion abuts against the resisting portion when the elastic arm is moved downwards.

### BACKGROUND OF THE INVENTION

### Field of the Invention

The present invention relates generally to a chip connector, and particularly to a chip connector with improved terminals.

### Description of Related Arts

U.S. Pat. No. 11,817,647 discloses a chip connector for connecting a chip module to a circuit board, comprising a base with a resilient contacting arm, a retaining section sidewardly linked to one side edge of the base, and a supporting section sidewardly linked to another side edge of the base with an outwardly and upwardly curved abutting section at an upper end thereof. A side edge of the resilient contacting arm may contact with the curved abutting section when the resilient contacting arm is pressed. A poor contact is made between the resilient arm and the abutting section as the side edge of the resilient contacting arm is linear and the abutting section is curved.

Therefore, a chip connector with improved terminals is desired.

### SUMMARY OF THE INVENTION

The objective of the present invention is to provide a chip connector with improved retaining terminals.

To achieve the above object, a chip connector comprises: an insulative housing defining an upper face, a lower face, and a plurality of terminal grooves extending through the upper face and the lower face; and a plurality of conductive terminals received in the terminal grooves respectively, each terminal comprising a fixing portion, an elastic arm extending from the fixing portion, a tail portion, and an accessory portion, the elastic arm comprising an upward portion, an inclined portion extending obliquely from the upward portion, and a contacting portion bending from the inclined portion, wherein the accessory portion comprises a slanting portion with a resisting portion at a free end thereof, the slanting portion faces and extends toward the fixing portion, and the inclined portion abuts against the resisting portion when the elastic arm is moved downwards.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a chip connector of a first embodiment of this present invention;

FIG. 2 is an exploded perspective view of the chip connector of FIG. 1;

FIG. 3 is a front view of a terminal and a solder ball of FIG. 2;

FIG. 4 is a side view of the terminal and the solder ball of FIG. 2;

FIG. 5 is the side view of the deformed terminal wherein a contacting portion resists on an elastic arm of FIG. 4;

FIG. 6 is a perspective view of a terminal and the solder ball of a second embodiment of this present invention;

FIG. 7 is a front view of a terminal and a solder ball of FIG. 6;

FIG. 8 is a side view of the terminal and the solder ball of FIG. 6; and

FIG. 9 is a side view of the deformed terminal when the contacting portion resists on the elastic arm of FIG. 6.

### DETAILED DESCRIPTION OF THE PREFERRED EMBODIMENT

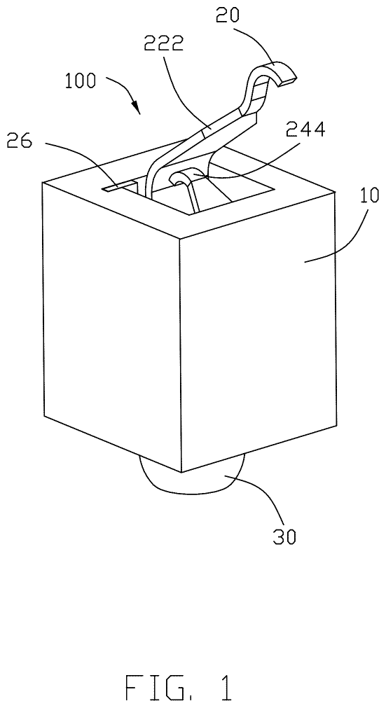

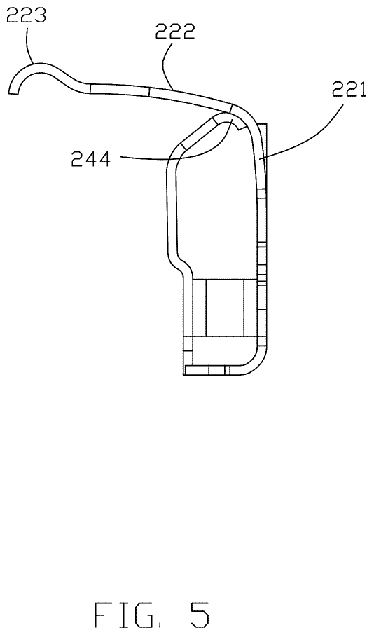

Referring to FIGS. 1-5, a chip connector 100 adapted for electrically connecting a chip module to a circuit board of a first embodiment is illustrated. The chip connector 100 comprises an insulative housing 10 with an upper face and a lower face, and a plurality of conductive terminals 20. In FIG. 1 only part of the insulating housing with one terminal groove 101 is shown. The insulating housing 10 has plural terminal grooves 101, and the terminals 20 are retained in corresponding terminal grooves 101 respectively. Each terminal 20 comprises a fixing portion 21 received and retained in the terminal groove 101, an elastic arm 22 extending from the fixing portion 21, a tail portion 23a, and an accessory portion 24. The elastic arm 22 comprises an upward portion 221 extending upwardly from the fixing portion 21, an inclined portion 222 and a spoon shaped contacting portion 223 in turn. The accessory portion 24 includes a slanting portion 243 facing and extending obliquely toward the fixing portion 21 and a spoon shaped resisting portion 244 opening downwardly. In this embodiment, the accessory portion 24 comprises a vertical portion 242 facing the fixing portion 21 and an expanding portion 241 extending upwardly and outwardly from the vertical portion 242. The expanding portion 241 is farther from the fixing portion 21 than the vertical portion 242. Referring to FIG. 5, the resisting portion 244 is able to resist against the inclined portion 222 near the upward portion 221 when the elastic arm 22 is pressed downwards.

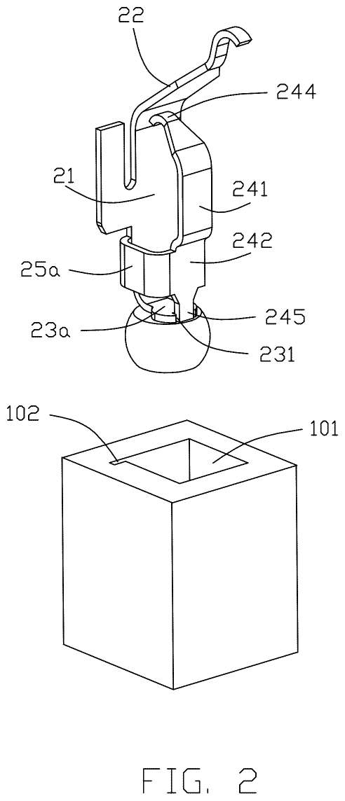

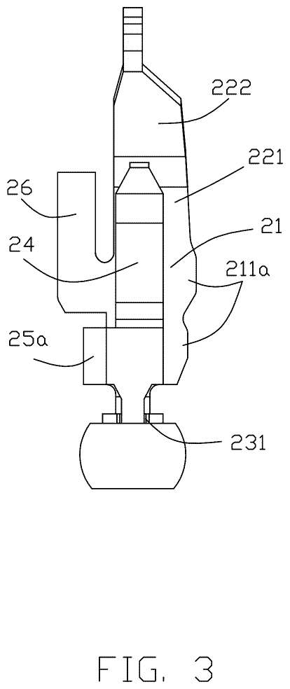

Referring to FIGS. 2-3, the accessory portion 24 further comprises an accessory tail portion 245 extending from the vertical portion 242 downwardly. In this embodiment, the tail portion 23a, which is of a pad shape, is formed by bending from a lower end of the fixing portion 21 firstly and then extending horizontally. The accessory tail portion 245 is in a strip shape, the tail portion 23a has a slot 231 in which the accessory tail portion 245 is received. The tail portion 23a and the accessory tail portion 245 are jointly soldered to a circuit board (not labbed) by fusion welding of a solder ball 30 under them.

Referring to FIGS. 2-3, the accessory portion 24 is connected with the fixing portion 21 by a bridge portion 25, and the bridge portion 25 is between the fixing portion 21 and the vertical portion 242 for making the accessory portion 24 firmly connected to the fixing portion 21 at the opposite of the fixing portion 21. The fixing portion 21 has a strip connecting portion 26 spaced apart from a first side edge thereof. In this embodiment, the bridge portion 25 and the strip connecting portion 26 are at the same side of the fixing portion 21 and the bridge portion 25 is under the connecting portion 26. The fixing portion 21 has plural barbs 211a at another side edge opposite to the first side edge thereof. The terminals 20 are assembled into the terminal grooves 101 by a strip (not shown) connecting with them first, and then, the strip is broken and separated from the connecting portion 26, leaving the terminals 20 together with the connecting portion 26 retained in the terminal grooves 101 respectively. The terminals 20 are stably fixed in the terminals grooves 101 by barbs 211a interferenced with corresponding inside face of the terminal grooves 101.

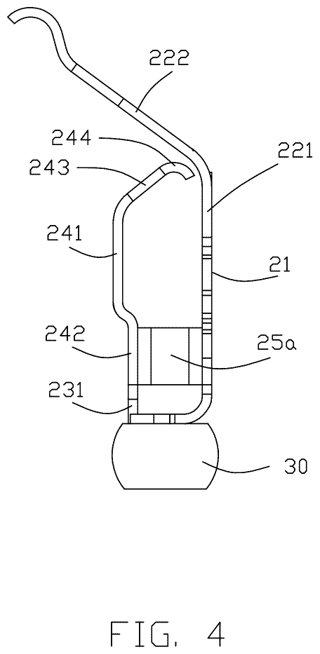

Referring to FIGS. 4-5, the terminals 20 can be soldered to a circuit board after the terminals 20 are retained in the terminal grooves 101 for fixing the chip connector 100 to the circuit board. The contacting portion 223 moves downward and drives the elastic arm 22 to approach the resisting portion 244 until an end of the inclined portion 222 near the upward portion 221 resists on the resisting portion 244, so two paths are formed for the elastic arm 22 to get electrically connected with the accessory portion 24, for one path, a current goes from the elastic arm 22 to the fixing portion 21, and then goes to the tail portion 23a, for another path, the current goes from the elastic arm 22 to the fixing portion 21, and then goes to the accessory tail portion 245.

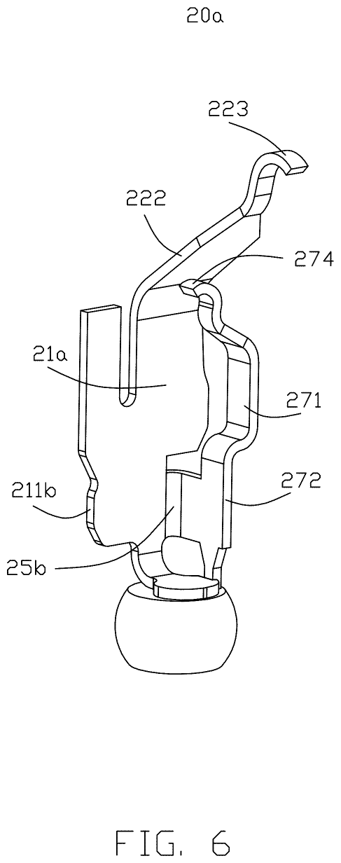

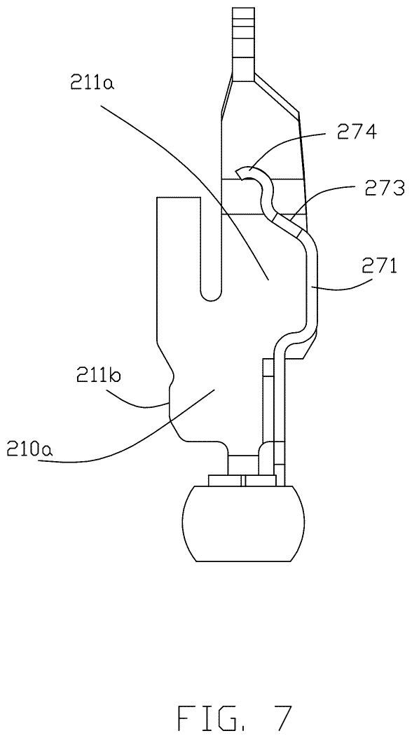

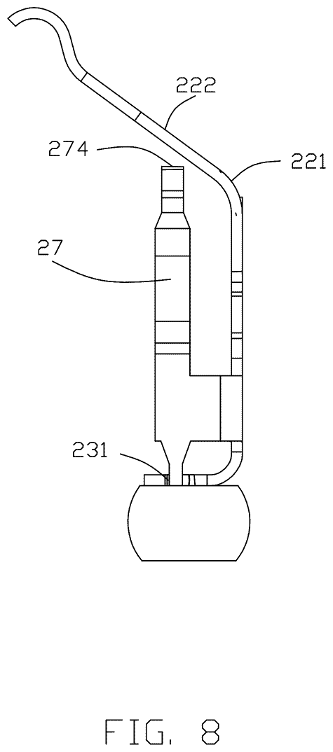

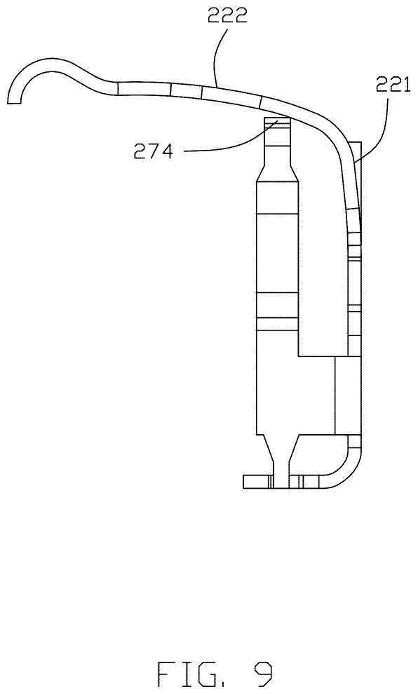

Referring to FIGS. 6 to 9, a terminal 20a in a second embodiment which is roughly the same as that in the first embodiment, is illustrated. In this embodiment, the same structures are labeled with same symbols and are not described in detail again, only the main differences are described below. The accessory portion 27 is perpendicular to the fixing portion 21a, and the fixing portion 21a is connected to the vertical portion 272 by a bridge portion 25b at a side thereof away from the strip connecting portion 26. The barbs 211b are formed at both sides of the fixing portion 21a, and the barb 211b at the same side with the bridge portion 25b is over the bridge portion 25b while the barb 211b at the same side with the strip connecting portion 26 is below the strip connecting portion 26. In addition, the barbs 211b at the side of the fixing portion 21a away from the bridge portion 25b are at same level as the bridge portion 25b. In this embodiment, the resisting portion 274 is immediately below the inclined portion 222 and can firmly resist on the inclined portion 222 when the latter is pressed downwards. In this embodiment, the fixing portion 21a has a narrow portion 210a near a lower end thereof and a wide portion 211a, the accessory portion 27 is connected with the narrow portion 210a by the bridge portion 25b and the expanding portion 271 is in front of the wide portion 211a.

The above-mentioned embodiments are only preferred embodiments of the present invention, and should not limit the scope of the present invention, any simple equivalent changes and modifications made according to the claims of the present invention and the contents of the description should still belong to the present invention.

1. A chip connector comprising:
an insulative housing defining an upper face, a lower face, and a plurality of terminal grooves extending through the upper face and the lower face; and
a plurality of conductive terminals received in the terminal grooves respectively, each terminal comprising a fixing portion, an elastic arm extending from the fixing portion, a tail portion, and an accessory portion, the elastic arm comprising an upward portion, an inclined portion extending obliquely from the upward portion, and a contacting portion bending from the inclined portion;
wherein the accessory portion comprises a slanting portion with a resisting portion at a free end thereof, the slanting portion faces and extends toward the fixing portion, and the inclined portion abuts against the resisting portion when the elastic arm is moved downwards.

2. The chip connector as claimed in claim 1, wherein the tail portion has a slot, and the accessory portion has an accessory tail portion extending downwardly into the slot to connect with the tail portion.

3. The chip connector as claimed in claim 2, wherein the accessory portion has a vertical portion facing the fixing portion and an expanding portion extending upwardly and outwardly from the vertical portion, the expanding portion faces the vertical portion and is farther from the fixing portion than the vertical portion, the accessory tail portion extends downwardly from the vertical portion, and the slanting portion extends upwardly and obliquely from the expanding portion.

4. The chip connector as claimed in claim 3, wherein the accessory portion is connected with the fixing portion by a bridge portion, and the bridge portion is located between the fixing portion and the vertical portion.

5. The chip connector as claimed in claim 4, wherein a strip connecting portion is linked to a side edge of the fixing portion by an upper end thereof spacing apart from the side edge of the fixing portion, and the strip connecting portion is located above the bridge portion.

6. The chip connector as claimed in claim 4, wherein the tail portion comprises a solder pad portion, and the solder pad portion is formed by bending from a lower end of the fixing portion firstly and then extending horizontally.

7. The chip connector as claimed in claim 2, wherein the tail portion and the accessory tail portion are soldered to a circuit board by a solder ball.

8. The chip connector as claimed in claim 4, wherein a plurality of barbs are formed at a side edge of the fixing portion away from the bridge portion.

9. A chip connector comprising:
an insulative housing defining an upper face, a lower face, and a plurality of terminal grooves extending through the upper face and the lower face; and
a plurality of conductive terminals received in the receiving grooves respectively, each terminal comprising a fixing portion, an elastic arm extending from the fixing portion, a tail portion, and an accessory portion, the elastic arm having an upward portion, an inclined portion extending obliquely from the upward portion and a contacting portion bending from the inclined portion;
wherein the accessory portion is located perpendicular to the fixing portion and comprises a slanting portion with a resisting portion under the inclined portion, the inclined portion resists against the resisting portion when the elastic arm is moved downwards.

10. The chip connector as claimed in claim 9, wherein the fixing portion has a narrow portion near a lower end thereof and a wide portion, and the accessory portion is connected with the narrow portion by a bridge portion.

11. The chip connector as claimed in claim 10, wherein the accessory portion has a vertical portion and an expanding portion extending upwardly and outwardly from the vertical portion, and the expanding portion is in front of the wide portion.

12. The chip connector as claimed in claim 10, wherein a side edge of the narrow portion away from the bridge portion and a side edge of the wide portion over the bridge portion have one or more barbs.

13. The chip connector as claimed in claim 10, wherein a strip connecting portion is linked to a side edge of the wide portion and is located over the barb of the narrow portion.

14. The chip connector as claimed in claim 10, wherein the elastic arm has an upward portion and an inclined portion extending obliquely from the upward portion, the contacting portion is at a free end of the inclined portion, and the resisting portion is able to resist against the inclined portion when the elastic arm is moved downwards.

15. A chip connector comprising:
an insulative housing defining an upper face, a lower face, and a plurality of terminal grooves extending through the upper face and the lower face; and
a plurality of conductive terminals received in the terminal grooves respectively, each terminal comprising a fixing portion, an elastic arm with a contacting portion, a tail portion, and an accessory portion;
wherein the tail portion having a horizontal pad portion with a slot, and the accessory portion is at least partly received in the slot.

16. The chip connector as claimed in claim 15, wherein the elastic arm has an inclined portion with the contacting portion at a distal end thereof, the accessory portion has a resisting portion arced downwards and located below the inclined portion, and the inclined portion resists against the resisting portion when the elastic arm is moved downwards.

17. The chip connector as claimed in claim 16, wherein the accessory portion has a vertical portion, a tail portion, an expanding portion extending upwardly and outwardly from the vertical portion, and a slanting portion with the resisting portion, the slanting portion extends upwardly and obliquely from the expanding portion, and the accessory tail portion extends downwardly from the vertical portion.
